(19) United States
(12) Patent Application Publication
(10) Pub. No.: US 2025/0243118 A1
(43) Pub. Date: Jul. 31, 2025

(54) METHODS OF FORMING CERAMIC SUBSTRATES

(71) Applicant: CORNING INCORPORATED, CORNING, NY (US)

(72) Inventors: Dane Alphanso Christie, Painted Post, NY (US); Joshua David Wade, Lindley, NY (US)

(21) Appl. No.: 19/032,919

(22) Filed: Jan. 21, 2025

Related U.S. Application Data
(60) Provisional application No. 63/625,140, filed on Jan. 25, 2024.

(51) Int. Cl. C04B 35/01; C04B 35/634; C04B 35/638; C04B 35/64

(52) U.S. Cl. CPC C04B 35/01; C04B 35/634; C04B 35/638; C04B 35/64; C04B 2235/3203

(57) ABSTRACT

A method of forming a ceramic substrate includes heating lithium cobaltite (LCO) precursor powder in a furnace at a furnace temperature greater than or equal to 300° C. and less than or equal to 950° C. to at least partially remove lithium from surfaces of particles of the LCO precursor powder, dispersing the LCO precursor powder in a binder and solvent to form a slurry, tape casting the slurry to form a tape, drying the tape to remove the solvent and form a green tape, debinding the green tape to remove the binder and form a brown tape, and sintering the brown tape to consolidate the LCO precursor powder and form a ceramic substrate. The binder includes poly(propylene carbonate), poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof.

### CROSS-REFERENCE TO RELATED APPLICATIONS

This application claims the benefit of priority under 35 U.S.C. § 119 of U.S. Provisional Application Ser. No. 63/625,140, filed on Jan. 25, 2024, the content of which is relied upon and incorporated herein by reference in its entirety.

### FIELD

The present specification generally relates to ceramic substrates and, in particular, to methods of forming ceramic substrates to suppress ribbon flammability.

### TECHNICAL BACKGROUND

Lithium-ion batteries are currently a popular chemistry for a variety of applications. One way to increase efficiency and reduce the cost of manufacturing lithium-containing ceramic ribbons, such as lithium cobaltite (LCO) ceramic ribbons, is to increase processing speeds. However, current binder packages for LCO, such as those based on poly(vinyl butyral) (PVB), may ignite during debinding if fired at speeds above 5 inches per minute.

Accordingly, a need exists for cost-effective methods of forming ceramic substrates.

### SUMMARY

According to a first aspect A1, a method of forming a ceramic substrate comprises: heating lithium cobaltite (LCO) precursor powder in a furnace at a furnace temperature greater than or equal to 300° C. and less than or equal to 950° C. to at least partially remove lithium from surfaces of particles of the LCO precursor powder; dispersing the LCO precursor powder in a binder and solvent to form a slurry, the binder comprising poly(propylene carbonate), poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof; tape casting the slurry to form a tape; drying the tape to remove the solvent and form a green tape; debinding the green tape to remove the binder and form a brown tape; and sintering the brown tape to consolidate the LCO precursor powder and form a ceramic substrate.

A second aspect A2 includes the method of the first aspect A1, wherein a debinding speed of the debinding is greater than 5 inches per minute.

A third aspect A3 includes the method of the first aspect A1 or the second aspect A2, wherein during the heating of the LCO precursor powder, the furnace comprises a humid atmosphere.

A fourth aspect A4 includes the method of the first aspect A1 or the second aspect A2, wherein during the heating of the LCO precursor powder, the furnace comprises a dry atmosphere.

A fifth aspect A5 includes the method of any one of the first through fourth aspects A1-A4, wherein a mean particle size of the LCO precursor powder is greater than or equal to 0.1 μm and less than or equal to 1.5 μm.

A sixth aspect A6 includes the method of any one of the first through fifth aspects A1-A5, wherein the heating the LCO precursor powder comprises heating the LCO precursor powder at the furnace temperature for greater than or equal to 0.1 hour and less than or equal to 10 hours.

A seventh aspect A7 includes the method of any one of the first through sixth aspects A1-A6, wherein the solvent comprises dimethyl carbonate, methylethyl ketone, toluene, methoxypropyl acetate, ethanol, butanol, isopropanol, propylpropionate, dioxane, dioxolane, ethyl acetate, anisole, xylene, cyclopentane, cyclohexane, cyclohexanone, methyl isobutyl ketone, or combinations thereof.

An eighth aspect A8 includes the method of any one of the first through seventh aspects A1-A7, wherein the slurry comprises: greater than or equal to 20 wt % and less than or equal to 60 wt % of the LCO precursor powder; greater than or equal to 5 wt % and less than or equal to 30 wt % of the binder; and greater than or equal to 25 wt % and less than or equal to 60 wt % of the solvent.

A ninth aspect A9 includes the method of any one of the first through eighth aspects A1-A8, wherein the slurry further comprises at least one of a plasticizer and a dispersant.

A tenth aspect A10 includes the method of the ninth aspect A9, wherein the plasticizer comprises dibutyl phthalate, bis(2-ethylhexyl) phthalate, benzyl butyl phthalate, diisobutyl phthalate, diethyl phthalate, diisononyl phthalate, polyethylene glycol, propylene carbonate, or combinations thereof.

An eleventh aspect A11 includes the method of the ninth aspect A9 or the tenth aspect A10, wherein the dispersant comprises oligomeric polyester, fatty acid, or combinations thereof.

A twelfth aspect A12 includes the method of any one of the first through eleventh aspects A1-A11, wherein the dispersing of the LCO precursor powder comprises milling the LCO precursor powder in the binder and the solvent.

A thirteenth aspect A13 includes the method of any one of the first through twelfth aspects A1-A12, wherein the debinding comprises heating the green tape at a debinding temperature greater than or equal to 200° C. and less than or equal to 500° C.

A fourteenth aspect A14 includes the method of any one of the first through thirteenth aspects A1-A13, wherein the debinding comprises heating the green tape for greater than or equal to 5 seconds and less than or equal to 120 seconds.

A fifteenth aspect A15 includes the method of any one of the first through fourteenth aspects A1-A14, wherein the sintering comprises heating the brown tape at a sintering temperature greater than or equal to 1000° C. and less than or equal to 1200° C.

A sixteenth aspect A16 includes the method of any one of the first through fifteenth aspects A1-A15, wherein the sintering comprises heating the brown tape for greater than or equal to 5 seconds and less than or equal to 600 seconds.

A seventeenth aspect A17 includes the method of any one of the first through sixteenth aspects A1-A16, wherein the drying comprises heating the tape at a drying temperature greater than or equal to 100° C. and less than or equal to 300° C.

An eighteenth aspect A18 includes the method of any one of the first through seventeenth aspects A1-A17, wherein the debinding the green tape and sintering the brown tape are a continuous process.

A nineteenth aspect A19 includes the method of any one of the first through eighteenth aspects A1-A18, wherein a porosity of the ceramic substrate is less than or equal to 35%.

A twentieth aspect A20 includes the method of any one of the first through nineteenth aspects A1-A19, wherein a thickness of the ceramic substrate is greater than or equal to 5 μm and less than or equal to 125 μm.

Additional features and advantages of the ceramic substrates and methods of forming same described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow chart of a method of forming a ceramic substrate, according to one or more embodiments described herein;

FIG. 2 is a schematic illustration of a continuous process, according to one or more embodiments described herein;

FIG. 3 is a schematic illustration of a ceramic substrate, according to one or more embodiments described herein;

FIG. 4 is a thermogravimetric profile of green tapes formed using heat treated precursor powders, according to one or more embodiments described herein;

FIG. 5 is a thermogravimetric profile of other green tapes formed using heat treated precursor powders, according to one or more embodiments described herein;

FIG. 6 is a thermogravimetric profile of other green tapes formed using heat treated precursor powders, according to one or more embodiments described herein;

FIG. 7 is a scanning electron microscope (SEM) image of a ceramic substrate, according to one or more embodiments described herein; and

FIG. 8 is a SEM image of another ceramic substrate, according to one or more embodiments described herein.

### DETAILED DESCRIPTION

Reference will now be made in detail to various embodiments of methods of forming ceramic substrates to suppress ribbon flammability. According to embodiments, a method of forming a ceramic substrate includes heating lithium cobaltite (LCO) precursor powder in a furnace at a furnace temperature greater than or equal to 300° C. and less than or equal to 950° C. to at least partially remove lithium from surfaces of particles of the LCO precursor powder, dispersing the LCO precursor powder in a binder and solvent to form a slurry, tape casting the slurry to form a tape, drying the tape to remove the solvent and form a green tape, debinding the green tape to remove the binder and form a brown tape, and sintering the brown tape to consolidate the LCO precursor powder and form a ceramic substrate. The binder includes poly(propylene carbonate), poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof.

Various embodiments of ceramic substrates and methods of forming same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “debinding,” as used herein, refers to heating the green tape at a debinding temperature such that thermolysis of the binder into small oligomers occurs and at least a portion of the binder is removed, thereby forming a brown tape.

The term “sintering,” as used herein, refers to heating the brown tape above at a sintering temperature to remove a remaining portion of the binder (e.g., oligomeric residue and thermolytic byproducts formed during debinding) and consolidate the LCO precursor powder, thereby forming a ceramic substrate.

The phrase “green tape,” as used herein, refers to a casted tape that has not undergone heat treatment to remove the binder.

The phrase “brown tape,” as used herein, refers to a casted tape that has undergone a debind heat treatment to remove at least a portion of the binder by thermolytic decomposition.

The size of the particles are measured using a Microtrac S3500. The term “d10,” as used herein, refers to the point on a particle size distribution curve below which 10% of the particles fall. The term “d50,” as used herein, refers to the point on a particle size distribution curve below which 50% of the particles fall. The term “d50 particle size” and “mean particle size” may be used interchangeably herein. The term “d90,” as used herein, refers to the point on a particle size distribution curve below which 90% of the particles fall.

The term “porosity,” as used herein, refers to a measure of the void spaces in a material. Porosity of ceramic substrates is determined by laser cutting a disk or other shape with a quantifiable area from a sintered ribbon. The disk or other shape is weighed and then the thickness measured such as with a laser gauge or from a cross-section view under an optical or scanning electron microscope. The porosity is readily computed according to the equation, POR=100(1−m/(Atρ_{L})) where A is the area, t is the thickness, m is the mass, and PL is the lattice density. Lattice density for LCO is 5.04 g/cm³, see J. N. Reimers and J. R. Dahn, “Electrochemical and In Situ X-Ray Diffraction Studies of Lithium Intercalation in LixCoO2,” J. Electrochem. Soc., 139 (1992) 2091-2097, DOI:10.1149/1.2221184. It is understood that in computation of porosity by this method for other substrate compositions that its lattice density should be utilized.

As mentioned herein, lithium-ion batteries are currently a popular chemistry for a variety of applications. For example, lithium-ion battery technology that is based on liquid carbonate electrolytes and intercalation electrodes are used in a variety of small electronic devices, such as cellular telephones, laptop computers, and cordless power tools, and also in larger applications, such as hybrid and all-electric vehicles and to stabilize electric grids at local and national levels under periods of high demand.

One way to increase efficiency and reduce the cost of manufacturing lithium-containing ceramic ribbons, such as lithium cobaltite (LCO) ceramic ribbons, is to increase processing speeds. Ceramic ribbons are formed as polymer/ceramic composite thin films or green tapes. Firing ceramic ribbons proceeds by pyrolysis or binder burnout of organic components to create a porous, sintering-compatible body. However, current binder packages for LCO, such as those based on poly(vinyl butyral) (PVB), may ignite during debinding if fired at speeds above 5 inches per minute.

Disclosed herein are methods of forming ceramic substrates which may mitigate the aforementioned problems. Specifically, methods of forming ceramic substrates disclosed herein involve a combination of a low temperature heat treatment (e.g., greater than or equal to 300° C. and less than or equal to 950° C.) of LCO precursor powder and replacement of conventional binder (e.g., PVB) with polypropylene carbonate, poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof to suppress ribbon flammability during relatively fast firing (e.g., debinding speed greater than 5 inches per minute). While not wishing to be bound by theory, it is believed that the interaction of lithium may cause ribbon flammability. During the low temperature heat treatment, lithium may be depleted from surfaces of particles of the LCO precursor powder, thereby stabilizing the sensitivity of the powder to binder pyrolysis and enabling relatively fast firing.

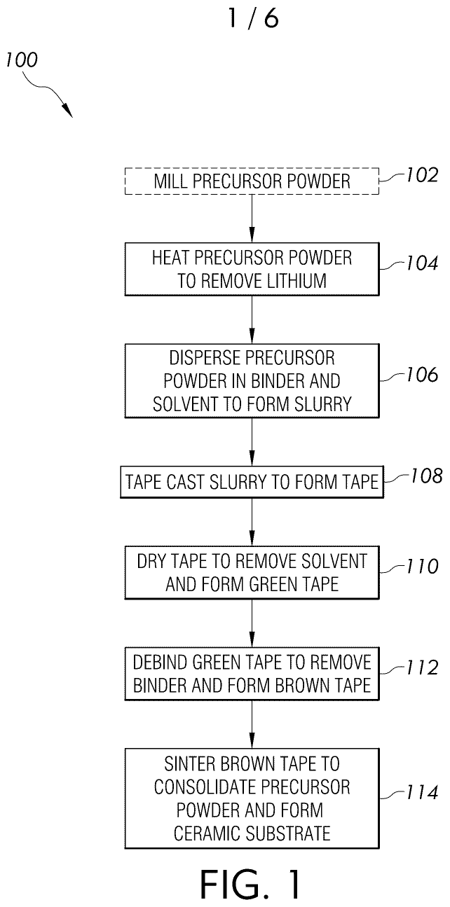

Referring now to FIG. 1, a method of forming a ceramic substrate is shown at 100. The method may optionally begin at block 102 with milling LCO precursor powder. Milling may ensure that the resulting LCO precursor powder has a desired mean particle size (e.g., greater than or equal to 0.1 μm and less than or equal to 1.5 μm).

The LCO precursor powder may have a minimum mean particle size (e.g., greater than or equal to 0.1 μm) to reduce or prevent agglomeration of the powder during heat treatment. The mean particle size of the LCO precursor powder may be limited (e.g., less than or equal to 1.5 μm) to ensure that the lithium is sufficiently depleted from surfaces of particles of the LCO precursor powder. Accordingly, in embodiments, a mean particle size of the LCO precursor powder may greater than or equal to 0.1 μm and less than or equal to 1.5 μm. In embodiments, the mean particle size of the LCO precursor powder may be greater than or equal to 0.1 μm, greater than or equal to 0.3 μm, or even greater than or equal to 0.5 μm. In embodiments, the mean particle size of the LCO precursor powder may be less than or equal to 1.5 μm, less than or equal to 1.25 μm, less than or equal to 1 μm, less than or equal to 0.75 μm, or even less than or equal to 0.5 μm. In embodiments, the mean particle size of the LCO precursor powder may greater than or equal to 0.1 μm and less than or equal to 1.5 μm, greater than or equal to 0.1 μm and less than or equal to 1.25 μm, greater than or equal to 0.1 μm and less than or equal to 1 μm, greater than or equal to 0.1 μm and less than or equal to 0.75 μm, greater than or equal to 0.1 μm and less than or equal to 0.5 μm, greater than or equal to 0.3 μm and less than or equal to 1.5 μm, greater than or equal to 0.3 μm and less than or equal to 1.25 μm, greater than or equal to 0.3 μm and less than or equal to 1 μm, greater than or equal to 0.3 μm and less than or equal to 0.75 μm, greater than or equal to 0.3 μm and less than or equal to 0.5 μm, greater than or equal to 0.5 μm and less than or equal to 1.5 μm, greater than or equal to 0.5 μm and less than or equal to 1.25 μm, greater than or equal to 0.5 μm and less than or equal to 1 μm, or even greater than or equal to 0.5 μm and less than or equal to 0.75 μm, or any and all sub-ranges formed from any of these endpoints.

In embodiments, a d10 particle size of the LCO precursor powder may be greater than or equal to 0.3 μm and less than or equal to 1 μm. In embodiments, the d10 particle size of the LCO precursor powder may be greater than or equal to 0.3 μm. In embodiments, the d10 particle size of the LCO precursor powder may be less than or equal to 1 μm, less than or equal to 0.75 μm, or even less than or equal to 0.5 μm. In embodiments, the d10 particle size of the LCO precursor powder may be greater than or equal to 0.3 μm and less than or equal to 1 μm, greater than or equal to 0.3 μm and less than or equal to 0.75 μm, or even greater than or equal to 0.3 μm and less than or equal to 0.5 μm, or any and all sub-ranges formed from any of these endpoints.

In embodiments, a d90 particle size of the LCO precursor powder may be greater than or equal to 0.5 μm and less than or equal to 2 μm. In embodiments, the d90 particle size of the LCO precursor powder may be greater than or equal to 0.5 μm, greater than or equal to 0.75 μm, greater than or equal to 1 μm, or even greater than or equal to 1.25 μm. In embodiments, the d90 particle size of the LCO precursor powder may be less than or equal to 2 μm even less than or equal to 1.75 μm. In embodiments, a d90 particle size of the LCO precursor powder may be greater than or equal to 0.5 μm and less than or equal to 2 μm, greater than or equal to 0.5 μm and less than or equal to 1.75 μm, greater than or equal to 0.75 μm and less than or equal to 2 μm, greater than or equal to 0.75 μm and less than or equal to 1.75 μm, greater than or equal to 1 μm and less than or equal to 2 μm, greater than or equal to 1 μm and less than or equal to 1.75 μm, greater than or equal to 1.25 μm and less than or equal to 2 μm, or even greater than or equal to 1.25 μm and less than or equal to 1.75 μm, or any and all sub-ranges formed from any of these endpoints.

Referring back to FIG. 1, the method 100 continues at block 104 with heating the LCO precursor powder in a furnace at a furnace temperature to at least partially remove lithium from surfaces of particles of the LCO precursor powder. As discussed herein, removing lithium from the surfaces of the LCO precursor powder may stabilize the sensitivity of the powder to binder pyrolysis, thereby enabling relatively fast firing (e.g., debinding speed greater than 5 inches per minute).

Lithium volatility, and thus, the depletion of lithium from the particles' surfaces, may increase with increasing temperature and/or increase atmospheric water content. Accordingly, the furnace temperature during heat treatment may depend on the atmosphere of the furnace and vice versa, but the relationship may not be linear.

The LCO precursor powder may be heat treated at a minimum furnace temperature (e.g., greater than or equal to 300° C.) to ensure lithium is depleted from the surfaces of the particles of the precursor powder. The furnace temperature during heat treatment may be limited (e.g., less than or equal to 950° C.) to reduce or avoid sintering at this step in the method. Accordingly, in embodiments, the furnace temperature during heating the LCO precursor powder may be greater than or equal to 300° C. and less than or equal to 950° C. In embodiments, the furnace temperature during heating the LCO precursor powder may be greater than or equal to 300° C., greater than or equal to 400° C., greater than or equal to 500° C., greater than or equal to 600° C., or even greater than or equal to greater than or equal to 700° C. In embodiments, the furnace temperature during heating the LCO precursor powder may be less than or equal to 950° C., less than or equal to 850° C., less than or equal to 750° C., less than or equal to 650° C., or even less than or equal to less than or equal to 550° C. In embodiments, the furnace temperature during heating the LCO precursor powder may be greater than or equal to 300° C. and less than or equal to 950° C., greater than or equal to 300° C. and less than or equal to 850° C., greater than or equal to 300° C. and less than or equal to 750° C., greater than or equal to 300° C. and less than or equal to 650° C., greater than or equal to 300° C. and less than or equal to 550° C., greater than or equal to 400° C. and less than or equal to 950° C., greater than or equal to 400° C. and less than or equal to 850° C., greater than or equal to 400° C. and less than or equal to 750° C., greater than or equal to 400° C. and less than or equal to 650° C., greater than or equal to 400° C. and less than or equal to 550° C., greater than or equal to 500° C. and less than or equal to 950° C., greater than or equal to 500° C. and less than or equal to 850° C., greater than or equal to 500° C. and less than or equal to 750° C., greater than or equal to 500° C. and less than or equal to 650° C., greater than or equal to 500° C. and less than or equal to 550° C., greater than or equal to 600° C. and less than or equal to 950° C., greater than or equal to 600° C. and less than or equal to 850° C., greater than or equal to 600° C. and less than or equal to 750° C., greater than or equal to 600° C. and less than or equal to 650° C., greater than or equal to 700° C. and less than or equal to 950° C., greater than or equal to 700° C. and less than or equal to 850° C., or even greater than or equal to 700° C. and less than or equal to 750° C., or any and all sub-ranges formed from any of these endpoints.

In embodiments, during the heating of the LCO precursor powder, the furnace may comprise a humid atmosphere (e.g., air bubbled through a water-containing vessel operated at a temperature ranging from 30° C. to 95° C.). In embodiments, during the heating of the LCO precursor powder, the furnace may comprise a dry atmosphere (e.g., air passed through a packed column containing drierite).

The LCO precursor powder may be heat treated at a furnace temperature, in a furnace atmosphere, and for a period of time sufficient to at least partially remove lithium from the surfaces of the particles of the LCO precursor powder. In embodiments, the heating the LCO precursor powder may comprise heating the LCO precursor powder at the furnace temperature for greater than or equal to 0.1 hour and less than or equal to 10 hours. In embodiments, the LCO precursor powder may be heated at the furnace temperature for greater than or equal to 0.1 hour, greater than or equal to 0.5 hour, greater than or equal to 1 hour, greater than or equal to 2 hours, or even greater than or equal to 4 hours. In embodiments, the LCO precursor powder may be heated at the furnace temperature for less than or equal to 10 hours, less than or equal to 8 hours, less than or equal to 6 hours, less than or equal to 4 hours, or even less than or equal to 2 hours. In embodiments, the LCO precursor powder may be heated at the furnace temperature for greater than or equal to 0.1 hour and less than or equal to 10 hours, greater than or equal to 0.1 hour and less than or equal to 8 hours, greater than or equal to 0.1 hour and less than or equal to 6 hours, greater than or equal to 0.1 hour and less than or equal to 4 hours, greater than or equal to 0.5 hour and less than or equal to 10 hours, greater than or equal to 0.5 hour and less than or equal to 8 hours, greater than or equal to 0.5 hour and less than or equal to 6 hours, greater than or equal to 0.5 hour and less than or equal to 4 hours, greater than or equal to 1 hour and less than or equal to 10 hours, greater than or equal to 1 hour and less than or equal to 8 hours, greater than or equal to 1 hour and less than or equal to 6 hours, greater than or equal to 1 hour and less than or equal to 4 hours, greater than or equal to 2 hours and less than or equal to 10 hours, greater than or equal to 2 hours and less than or equal to 8 hours, greater than or equal to 2 hours and less than or equal to 6 hours, greater than or equal to 2 hours and less than or equal to 4 hours, greater than or equal to 4 hours and less than or equal to 10 hours, greater than or equal to 4 hours and less than or equal to 8 hours, or even greater than or equal to 4 hours and less than or equal to 6 hours, or any and all sub-ranges formed from any of these endpoints.

Referring back to FIG. 1, the method 100 continues at block 106 with dispersing the LCO precursor powder in a binder and solvent to form a slurry. The slurry may be formed by dispersing the precursor powder into the solvent using, for example, ball mill. The binder may be added and mixed in a second step, with time provided for homogenization, using ball mill or a mixer. Any milling media may be separated from the slurry during a filtration process, for example, using a screen. In embodiments, the slurry may be rolled, for example, using rollers operating at about 25 RPM for about 18-24 hours to remove air within the slurry such that the resulting ceramic substrate may be voidless. In embodiments, the slurry may be deaired in a solvent-laden vacuum chamber for 5 to 10 minutes prior to tape casting.

A sufficient amount of LCO precursor powder (e.g., greater than or equal to 20 wt %) may be included in the slurry to ensure that the resulting ceramic substrate has a desired porosity (e.g., less than or equal to 35%) and thickness (e.g., greater than or equal to 5 μm). The amount of the LCO precursor powder may be limited (e.g., less than or equal to 60 wt %) to ensure enough binder is present to maintain mechanical integrity during tape casting and drying. In embodiments, the slurry may comprise greater than or equal to 20 wt % and less than or equal to 60 wt % of the LCO precursor powder. In embodiments, the amount of the LCO precursor powder in the slurry may be greater than or equal to 20 wt %, greater than or equal to 25 wt %, greater than or equal to 30 wt %, greater than or equal to 35 wt %, or even greater than or equal to 40 wt %. In embodiments, the amount of the LCO precursor powder in the slurry may be less than or equal to 60 wt %, less than or equal to 55 wt %, less than or equal to 50 wt %, less than or equal to 30 wt %, or even less than or equal to 40 wt %. In embodiments, the amount of the LCO precursor powder in the slurry may be greater than or equal to 20 wt % and less than or equal to 60 wt %, greater than or equal to 20 wt % and less than or equal to 55 wt %, greater than or equal to 20 wt % and less than or equal to 50 wt %, greater than or equal to 20 wt % and less than or equal to 45 wt %, greater than or equal to 20 wt % and less than or equal to 40 wt %, greater than or equal to 25 wt % and less than or equal to 60 wt %, greater than or equal to 25 wt % and less than or equal to 55 wt %, greater than or equal to 25 wt % and less than or equal to 50 wt %, greater than or equal to 25 wt % and less than or equal to 45 wt %, greater than or equal to 25 wt % and less than or equal to 40 wt %, greater than or equal to 30 wt % and less than or equal to 60 wt %, greater than or equal to 30 wt % and less than or equal to 55 wt %, greater than or equal to 30 wt % and less than or equal to 50 wt %, greater than or equal to 30 wt % and less than or equal to 45 wt %, greater than or equal to 30 wt % and less than or equal to 40 wt %, greater than or equal to 35 wt % and less than or equal to 60 wt %, greater than or equal to 35 wt % and less than or equal to 55 wt %, greater than or equal to 35 wt % and less than or equal to 50 wt %, greater than or equal to 35 wt % and less than or equal to 45 wt %, greater than or equal to 35 wt % and less than or equal to 40 wt %, greater than or equal to 40 wt % and less than or equal to 60 wt %, greater than or equal to 40 wt % and less than or equal to 55 wt %, greater than or equal to 40 wt % and less than or equal to 50 wt %, or even greater than or equal to 40 wt % and less than or equal to 45 wt %, or any and all sub-ranges formed from any of these endpoints.

As discussed herein, replacement of conventional binder (e.g., PVB) with the binder disclosed herein, in combination with a low temperature heat treatment (e.g., greater than or equal to 300° C. and less than or equal to 950° C.) of LCO precursor powder, suppresses ribbon flammability during relatively fast firing (e.g., debinding speed greater than 5 inches per minute). In embodiments, the binder may comprise poly(propylene carbonate), poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof.

A sufficient amount of binder (e.g., greater than or equal to 5 wt %) may be included in the slurry to ensure mechanical integrity is maintained during tape casting and drying. The amount of binder may be limited (e.g., less than or equal to 30 wt %) to ensure a sufficient amount of LCO precursor powder is present to form a ceramic substrate having desirable properties (e.g., a porosity less than 35% and a thickness greater than or equal to 5 μm). In embodiments, the slurry may comprise greater than or equal to 5 wt % and less than or equal to 30 wt % of the binder. In embodiments, the amount of the binder in the slurry may be greater than or equal to 5 wt %, greater than or equal to 7 wt %, greater than or equal to 10 wt %, greater than or equal to 12 wt %, or even greater than or equal to 15 wt %. In embodiments, the amount of the binder in the slurry may be less than or equal to 30 wt %, less than or equal to 25 wt %, less than or equal to 20 wt %, or even less than or equal to 15 wt %. In embodiments, the amount of the binder in the slurry may be greater than or equal to 5 wt % and less than or equal to 30 wt %, greater than or equal to 5 wt % and less than or equal to 25 wt %, greater than or equal to 5 wt % and less than or equal to 20 wt %, greater than or equal to 5 wt % and less than or equal to 15 wt %, greater than or equal to 7 wt % and less than or equal to 30 wt %, greater than or equal to 7 wt % and less than or equal to 25 wt %, greater than or equal to 7 wt % and less than or equal to 20 wt %, greater than or equal to 7 wt % and less than or equal to 15 wt %, greater than or equal to 10 wt % and less than or equal to 30 wt %, greater than or equal to 10 wt % and less than or equal to 25 wt %, greater than or equal to 10 wt % and less than or equal to 20 wt %, greater than or equal to 10 wt % and less than or equal to 15 wt %, greater than or equal to 12 wt % and less than or equal to 30 wt %, greater than or equal to 12 wt % and less than or equal to 25 wt %, greater than or equal to 12 wt % and less than or equal to 20 wt %, greater than or equal to 12 wt % and less than or equal to 15 wt %, greater than or equal to 15 wt % and less than or equal to 30 wt %, greater than or equal to 15 wt % and less than or equal to 25 wt %, or even greater than or equal to 15 wt % and less than or equal to 20 wt %, or any and all sub-ranges formed from any of these endpoints.

In embodiments, the solvent may comprise dimethyl carbonate, methylethyl ketone, toluene, methoxypropyl acetate, ethanol, butanol, isopropanol, propylpropionate, dioxane, dioxolane, ethyl acetate, anisole, xylene, cyclopentane, cyclohexane, cyclohexanone, methyl isobutyl ketone, or combinations thereof.

In embodiments, the slurry may comprise greater than or equal to 25 wt % and less than or equal to 60 wt % of the solvent. In embodiments, the amount of the solvent in the slurry may be greater than or equal to 25 wt %, greater than or equal to 30 wt %, or even greater than or equal to 35 wt %. In embodiments, the amount of the solvent in the slurry may be less than or equal to 60 wt %, less than or equal to 55 wt %, less than or equal to 50 wt %, less than or equal to 25 wt %, or even less than or equal to 40 wt %. In embodiments, the amount of the solvent in the slurry may be greater than or equal to 25 wt % and less than or equal to 60 wt %, greater than or equal to 25 wt % and less than or equal to 55 wt %, greater than or equal to 25 wt % and less than or equal to 50 wt %, greater than or equal to 25 wt % and less than or equal to 45 wt %, greater than or equal to 25 wt % and less than or equal to 40 wt %, greater than or equal to 30 wt % and less than or equal to 60 wt %, greater than or equal to 30 wt % and less than or equal to 55 wt %, greater than or equal to 30 wt % and less than or equal to 50 wt %, greater than or equal to 30 wt % and less than or equal to 45 wt %, greater than or equal to 30 wt % and less than or equal to 40 wt %, greater than or equal to 35 wt % and less than or equal to 60 wt %, greater than or equal to 35 wt % and less than or equal to 55 wt %, greater than or equal to 35 wt % and less than or equal to 50 wt %, greater than or equal to 35 wt % and less than or equal to 45 wt %, or even greater than or equal to 35 wt % and less than or equal to 40 wt %, or any and all sub-ranges formed from any of these endpoints.

The slurry may further include additives, such as at least one of a plasticizer and a dispersant.

In embodiments, the plasticizer may comprise dibutyl phthalate, bis(2-ethylhexyl) phthalate, benzyl butyl phthalate, diisobutyl phthalate, diethyl phthalate, diisononyl phthalate, polyethylene glycol, propylene carbonate, or combinations thereof. In embodiments, the amount of the plasticizer in the slurry may be greater than or equal to 0.1 wt % and less than or equal to 4 wt %, greater than or equal to 0.1 wt % and less than or equal to 2 wt %, greater than or equal to 0.5 wt % and less than or equal to 4 wt %, greater than or equal to 0.5 wt % and less than or equal to 2 wt %, greater than or equal to 1 wt % and less than or equal to 4 wt %, or even greater than or equal to 1 wt % and less than or equal to 2 wt %, or any and all sub-ranges formed from any of these endpoints.

In embodiments, the dispersant may comprise oligomeric polyester (e.g. HYPERMER KD73), fatty acid, or combinations thereof. Other commercial embodiments of the dispersant may include HYPERMER series, MALIALIM series, TRITON series, and SOLSPERSE series. In embodiments, the amount of the dispersant in the slurry may be greater than or equal to 0.1 wt % and less than or equal to 2 wt %, greater than or equal to 0.1 wt % and less than or equal to 1 wt %, greater than or equal to 0.5 wt % and less than or equal to 2 wt %, or even greater than or equal to 0.5 wt % and less than or equal to 1 wt %, or any and all sub-ranges formed from any of these endpoints.

Referring back to FIG. 1, the method 100 continues at block 108 with tape casting the slurry to form a tape. The slurry may be cast in a tape casting process using, for example, a hydraulically driven tape caster. In embodiments, the slurry may be tape cast onto a carrier (e.g., a Mylar carrier with a silicon release layer).

Referring back to FIG. 1, the method continues at block 110 with drying the tape to remove the solvent and form a green tape. In embodiments, the drying may comprise heating the tape at a drying temperature greater than or equal to 100° C. and less than or equal to 300° C., greater than or equal to 100° C. and less than or equal to 250° C., greater than or equal to 100° C. and less than or equal to 200° C., greater than or equal to 150° C. and less than or equal to 300° C., greater than or equal to 150° C. and less than or equal to 250° C., or even greater than or equal to 150° C. and less than or equal to 200° C., or any and all sub-ranges formed from any of these endpoints. The drying may comprise heating the tape at the drying temperature for greater than or equal to 1 min and less than or equal to 10 min, greater than or equal to 1 min and less than or equal to 5 min, greater than or equal to 2 min and less than or equal to 10 min, or even greater than or equal to 2 min and less than or equal to 5 min, or any and all sub-ranges formed from any of these endpoints.

The green tape may shrink during debinding and/or sintering when forming the ceramic substrate such that the thickness of the green tape is greater than the ceramic substrate formed therefrom. As such, the thickness of the green tape may be adjusted to account for this shrinkage in forming a ceramic substrate having a desired thickness. In embodiments, a thickness of the green tape may be greater than or equal to 7 μm and less than or equal to 200 μm. In embodiments, the thickness of the green tape may be greater than or equal to 7 μm, greater than or equal to 10 μm, greater than or equal to 15 μm, greater than or equal to 20 μm, or even greater than or equal to 25 μm. In embodiments, the thickness of the green tape may be less than or equal to 200 μm, less than or equal to 150 μm, less than or equal to 100 μm, or even less than or equal to 50 μm. In embodiments, a thickness of the green tape may be greater than or equal to 7 μm and less than or equal to 200 μm, greater than or equal to 7 μm and less than or equal to 150 μm, greater than or equal to 7 μm and less than or equal to 100 μm, greater than or equal to 7 μm and less than or equal to 50 μm, greater than or equal to 10 μm and less than or equal to 200 μm, greater than or equal to 10 μm and less than or equal to 150 μm, greater than or equal to 10 μm and less than or equal to 100 μm, greater than or equal to 10 μm and less than or equal to 50 μm, greater than or equal to 15 μm and less than or equal to 200 μm, greater than or equal to 15 μm and less than or equal to 150 μm, greater than or equal to 15 μm and less than or equal to 100 μm, greater than or equal to 15 μm and less than or equal to 50 μm, greater than or equal to 20 μm and less than or equal to 200 μm, greater than or equal to 20 μm and less than or equal to 150 μm, greater than or equal to 20 μm and less than or equal to 100 μm, greater than or equal to 20 μm and less than or equal to 50 μm, greater than or equal to 25 μm and less than or equal to 200 μm, greater than or equal to 25 μm and less than or equal to 150 μm, greater than or equal to 25 μm and less than or equal to 100 μm, or even greater than or equal to 25 μm and less than or equal to 50 μm, or any and all sub-ranges formed from any of these endpoints.

Referring back to FIG. 1, the method continues at block 112 with debinding the green tape to remove the binder and form a brown tape. As described herein, a combination of a low temperature heat treatment (e.g., greater than or equal to 300° C. and less than or equal to 950° C.) of LCO precursor powder and replacement of conventional binder (e.g., PVB) with polypropylene carbonate, poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof to suppress ribbon flammability during relatively fast firing (e.g., debinding speed greater than 5 inches per minute). Removing binder from the tape helps to reduce or prevent char residue in the final ceramic substrate.

In embodiments, the debinding speed may be greater than 5 inches per minute, greater than 10 inches per minute, greater than 25 inches per minute, or even greater than 50 inches per minute.

The debinding may comprise heating the green tape at a debinding temperature greater than or equal to 200° C. and less than or equal to 500° C. In embodiments, the debinding temperature may be greater than or equal to 200° C. or even greater than or equal to 250° C. In embodiments, the debinding temperature may be less than or equal to 500° C., less than or equal to 400° C., or even less than or equal to 300° C. In embodiments, the debinding temperature may be greater than or equal to 200° C. and less than or equal to 500° C., greater than or equal to 200° C. and less than or equal to 400° C., greater than or equal to 200° C. and less than or equal to 300° C., greater than or equal to 250° C. and less than or equal to 500° C., greater than or equal to 250° C. and less than or equal to 400° C., or even greater than or equal to 250° C. and less than or equal to 300° C., or any and all sub-ranges formed from any of these endpoints.

In embodiments, the debinding may comprise heating the green tape for greater than or equal to 5 seconds and less than or equal to 120 seconds. In embodiments, the debinding may comprise heating the green tape for greater than or equal to 5 seconds, greater than or equal to 10 seconds, greater than or equal to 20 seconds, or even greater than or equal to 30 seconds. In embodiments, the debinding may comprises heating the green tape for less than or equal to 120 seconds, less than or equal to 100 seconds, less than or equal to 80 seconds, or even less than or equal to 60 seconds. In embodiments, the debinding may comprise heating the green tape for greater than or equal to 5 seconds and less than or equal to 120 seconds, greater than or equal to 5 seconds and less than or equal to 100 seconds, greater than or equal to 5 seconds and less than or equal to 80 seconds, greater than or equal to 5 seconds and less than or equal to 60 seconds, greater than or equal to 10 seconds and less than or equal to 120 seconds, greater than or equal to 10 seconds and less than or equal to 100 seconds, greater than or equal to 10 seconds and less than or equal to 80 seconds, greater than or equal to 10 seconds and less than or equal to 60 seconds, greater than or equal to 20 seconds and less than or equal to 120 seconds, greater than or equal to 20 seconds and less than or equal to 100 seconds, greater than or equal to 20 seconds and less than or equal to 80 seconds, greater than or equal to 20 seconds and less than or equal to 60 seconds, greater than or equal to 30 seconds and less than or equal to 120 seconds, greater than or equal to 30 seconds and less than or equal to 100 seconds, greater than or equal to 30 seconds and less than or equal to 80 seconds, or even greater than or equal to 30 seconds and less than or equal to 60 seconds, or any and all sub-ranges formed from any of these endpoints.

Referring back to FIG. 1, the method 100 continues at block 114 with sintering the brown tape to consolidate the LCO precursor powder and form a ceramic substrate. In embodiments, the sintering may comprising heating the brown tape at a sintering temperature greater than or equal to 1000° C. and less than or equal to 1200° C. In embodiments, the sintering temperature may be greater than or equal to 1000° C. or even greater than or equal to 1050° C. In embodiments, the sintering temperature may be less than or equal to 1200° C. or even less than or equal to 1100° C. In embodiments, the sintering temperature may be greater than or equal to 1000° C. and less than or equal to 1200° C., greater than or equal to 1000° C. and less than or equal to 1100° C., greater than or equal to 1050° C. and less than or equal to 1200° C., greater than or equal to 1050° C. and less than or equal to 1100° C., or any and all sub-ranges formed from any of these endpoints.

In embodiments, the sintering may comprise heating the brown tape for greater than or equal to 5 seconds and less than or equal to 600 seconds. In embodiments, the sintering may comprise heating the brown tape for greater than or equal to 5 seconds, greater than or equal to 30 seconds, greater than or equal to 60 seconds, greater than or equal to 90 seconds, or even greater than or equal to 120 seconds. In embodiments, the sintering may comprise heating the brown tape for less than or equal to 600 seconds, less than or equal to 480 seconds, less than or equal to 360 seconds, or even less than or equal to 240 seconds. In embodiments, the sintering may comprise heating the brown tape for greater than or equal to 5 seconds and less than or equal to 600 seconds, greater than or equal to 5 seconds and less than or equal to 480 seconds, greater than or equal to 5 seconds and less than or equal to 360 seconds, greater than or equal to 5 seconds and less than or equal to 240 seconds, greater than or equal to 30 seconds and less than or equal to 600 seconds, greater than or equal to 30 seconds and less than or equal to 480 seconds, greater than or equal to 30 seconds and less than or equal to 360 seconds, greater than or equal to 30 seconds and less than or equal to 240 seconds, greater than or equal to 60 seconds and less than or equal to 600 seconds, greater than or equal to 60 seconds and less than or equal to 480 seconds, greater than or equal to 60 seconds and less than or equal to 360 seconds, greater than or equal to 60 seconds and less than or equal to 240 seconds, greater than or equal to 90 seconds and less than or equal to 600 seconds, greater than or equal to 90 seconds and less than or equal to 480 seconds, greater than or equal to 90 seconds and less than or equal to 360 seconds, greater than or equal to 90 seconds and less than or equal to 240 seconds, greater than or equal to 120 seconds and less than or equal to 600 seconds, greater than or equal to 120 seconds and less than or equal to 480 seconds, greater than or equal to 120 seconds and less than or equal to 360 seconds, or even greater than or equal to 120 seconds and less than or equal to 240 seconds, or any and all sub-ranges formed from any of these endpoints.

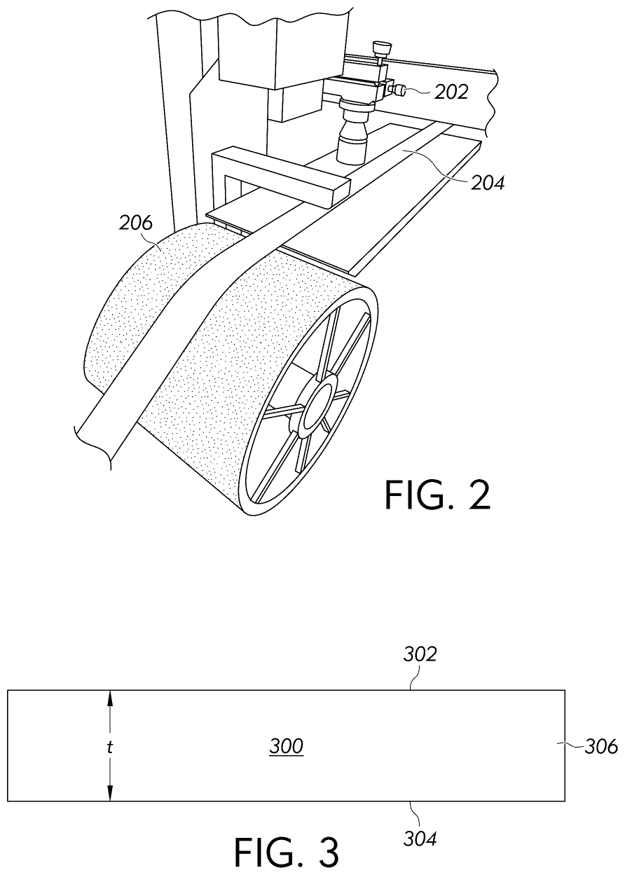

In embodiments, the debinding the green tape and sintering the brown tape may be a continuous process. Referring now to FIG. 2, in embodiments, the continuous process may comprise roll-to-roll processing. In roll-to-roll processing, the green tape (not shown) is drawn from a first drum (not shown) into a furnace 202 to sinter the green tape and form ceramic substrate 204. The ceramic substrate 204 is then advanced toward a second drum 206 for winding.

Referring now to FIG. 3, the ceramic substrate 300 comprises a first surface 302, a second surface 304 opposite the first surface 302, and a sintered polycrystalline material 306.

Removing lithium from the surface of the particles of the LCO precursor powder via heat treatment may help promote improved sintering of the precursor powder, thereby decreasing the porosity of the ceramic substrate 300. Accordingly, in embodiments, the ceramic substrate 300 may have a porosity less than 35%. In embodiments, a porosity of the ceramic substrate 300 may be greater than or equal to 0.1% and less than or equal to 35%. In embodiments, the porosity of the ceramic substrate 300 may be greater than or equal to 0.1%, greater than or equal to 0.5%, greater than or equal to 3%, or even greater than or equal to 5%. In embodiments, the porosity of the ceramic substrate 300 may be less than or equal to 35%, less than or equal to 25%, less than or equal to 15%, or even less than or equal to 5%. In embodiments, the porosity of the ceramic substrate 300 may be greater than or equal to 0.1% and less than or equal to 35%, greater than or equal to 0.1% and less than or equal to 25%, greater than or equal to 0.1% and less than or equal to 15%, greater than or equal to 0.1% and less than or equal to 5%, greater than or equal to 0.5% and less than or equal to 35%, greater than or equal to 0.5% and less than or equal to 25%, greater than or equal to 0.5% and less than or equal to 15%, greater than or equal to 0.5% and less than or equal to 5%, greater than or equal to 1% and less than or equal to 35%, greater than or equal to 1% and less than or equal to 25%, greater than or equal to 1% and less than or equal to 15%, greater than or equal to 1% and less than or equal to 5%, greater than or equal to 3% and less than or equal to 35%, greater than or equal to 3% and less than or equal to 25%, greater than or equal to 3% and less than or equal to 15%, greater than or equal to 3% and less than or equal to 5%, greater than or equal to 5% and less than or equal to 35%, greater than or equal to 5% and less than or equal to 25%, or even greater than or equal to 5% and less than or equal to 15%, or any and all sub-ranges formed from any of these endpoints.

The continuous debinding and sintering process may allow for relatively thicker ceramic substrates (e.g., greater than or equal to 5 μm) to be formed. In embodiments, a thickness t of the ceramic substrate 300 from the first surface 302 to the second surface 304 may be greater than or equal to 5 μm. In embodiments, the thickness t of the ceramic substrate 300 may be greater than or equal to 5 μm and less than or equal to 125 μm. In embodiments, the thickness t of the ceramic substrate 300 may be greater than or equal to 5 μm, greater than or equal to 10 μm, greater than or equal to 15 μm, or even greater than or equal to 20 μm. In embodiments, the thickness t of the ceramic substrate 300 may be less than or equal to 125 μm, less than or equal to 100 μm, less than or equal to 75 μm, or even less than or equal to 50 μm. In embodiments, the thickness t of the ceramic substrate 300 may be greater than or equal to 5 μm and less than or equal to 125 μm, greater than or equal to 5 μm and less than or equal to 100 μm, greater than or equal to 5 μm and less than or equal to 75 μm, greater than or equal to 5 μm and less than or equal to 50 μm, greater than or equal to 10 μm and less than or equal to 125 μm, greater than or equal to 10 μm and less than or equal to 100 μm, greater than or equal to 10 μm and less than or equal to 75 μm, greater than or equal to 10 μm and less than or equal to 50 μm, greater than or equal to 15 μm and less than or equal to 125 μm, greater than or equal to 15 μm and less than or equal to 100 μm, greater than or equal to 15 μm and less than or equal to 75 μm, greater than or equal to 15 μm and less than or equal to 50 μm, greater than or equal to 20 μm and less than or equal to 125 μm, greater than or equal to 20 μm and less than or equal to 100 μm, greater than or equal to 20 μm and less than or equal to 75 μm, or even greater than or equal to 20 μm and less than or equal to 50 μm, or any and all sub-ranges formed from any of these endpoints.

In embodiments, a width of the ceramic substrate 300 may be greater than or equal to 4 cm and a length of the ceramic substrate may be greater than or equal to 10 cm. In embodiments, a width of the ceramic substrate 300 may be greater than or equal to 4 cm, greater than or equal to 6 cm, greater than or equal to 8 cm, or even greater than or equal to 10 cm. In embodiments, a length of the ceramic substrate greater than or equal to 10 cm, greater than or equal to 25 cm, greater than or equal to 50 cm, or even greater than or equal to 100 cm.

### EXAMPLES

In order that various embodiments be more readily understood, reference is made to the following examples, which are intended to illustrate various embodiments of the ceramic substrates described herein.

Example Precursor Powders P1-P3, LCO powders having the particle size distribution listed in Table 1, were heat treated in a tube furnace at a furnace temperature from 300° C. to 950° C. for 0.1 hour in a humid atmosphere.

TABLE 1

| | Example Precursor Powders | | |
|---|---|---|---|
| | P1 | P2 | P3 |
| d10 (μm) | 5.48 | 0.343 | 0.254 |
| d50 (μm) | 10.38 | 0.621 | 0.391 |
| d90 (μm) | 18.77 | 1.672 | 1.201 |

Table 2 lists the slurry formulations of Example Green Tapes T1-T3, in weight percentages. Batch sizes were defined relative to 50 g of LCO. A 125 ml Nalgene bottle containing YSZ media (72 g of d=12 mm and 33 g of d=6.5 mm) was used for mixing. The slurries were prepared by first dispersing the precursor powders into a mixture of solvent and dispersant using ball mill and milling the mixture over a period of 1 to 3 days. Binder and plasticizer were added and mixed for a period of 0.5 to 3 days. After mixing, the slurries were deaired in a solvent-laden vacuum chamber for 5 to 10 minutes prior to casting. The slurries were cast via tape casting on a batch caster using a 200 μm gap single doctor blade to form the example tapes. The tapes were dried in a solvent-laden environment.

TABLE 2

| | Example Tapes | | |
|---|---|---|---|
| | T1 | T2 | T3 |
| Precursor Powder (LCO) | 49.2 | 49.2 | 31.9 |
| Solvent (dimethyl carbonate) | 37.5 | 37.5 | 46.9 |
| Dispersant (olgomeric | 0.7 | 0.7 | 0.5 |
| polyester) | | | |
| Binder (poly(propylene | 11.4 | 11.4 | 19.3 |
| carbonate)) | | | |
| Plasticizer (dibutyl | 1.2 | 1.2 | 1.4 |
| phthalate) | | | |

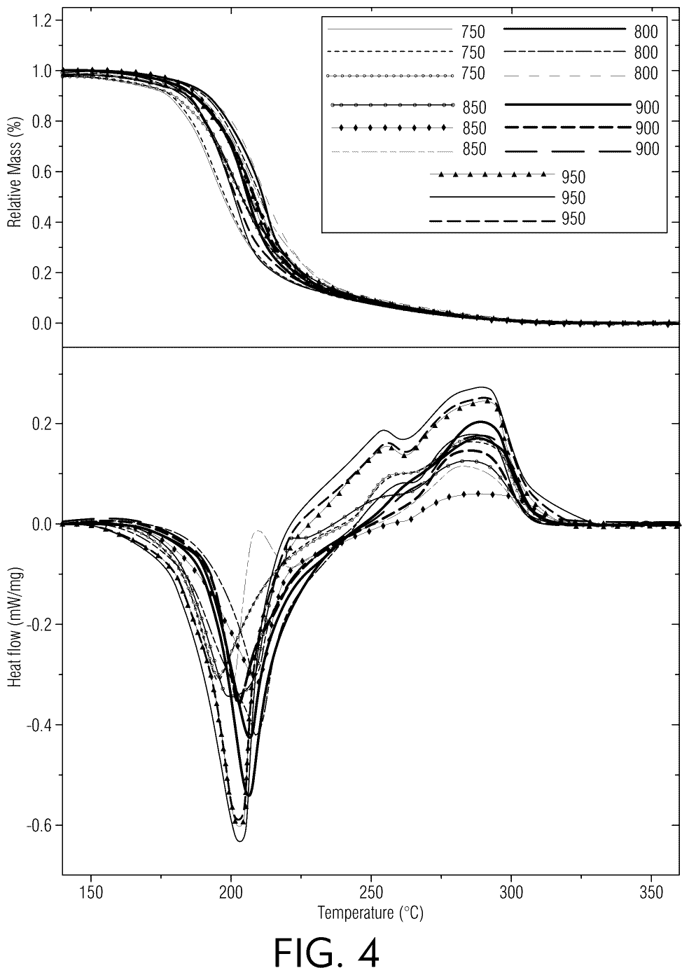

Thermogravimetric profiles of heat treated example green tapes are shown in FIGS. 4-6. The tapes were heated in air at a rate of 10° C./min.

In FIG. 4, the thermogravimetric profile of Example Green Tapes T1 formed using Example Precursor Powder P1 heat treated at a furnace temperature from 750° C. to 950° C., fractional mass loss of 0.50 was observed at temperatures ranging from 197° C. to 214° C. Negligible sensitivity of the loss profiles to the precursor power heat treatment temperature and furnace atmosphere was observed. Peak heat flow ranging from of 0.06 mW/mg to 0.27 mW/mg occurred at 287° C. The binder burnout temperature profile used to fire the tape may be set relative to the peak heat flow temperature. It may be desirable for the peak heat flow to be relatively low. A second heat signature, an endotherm, was observed at 202° C.

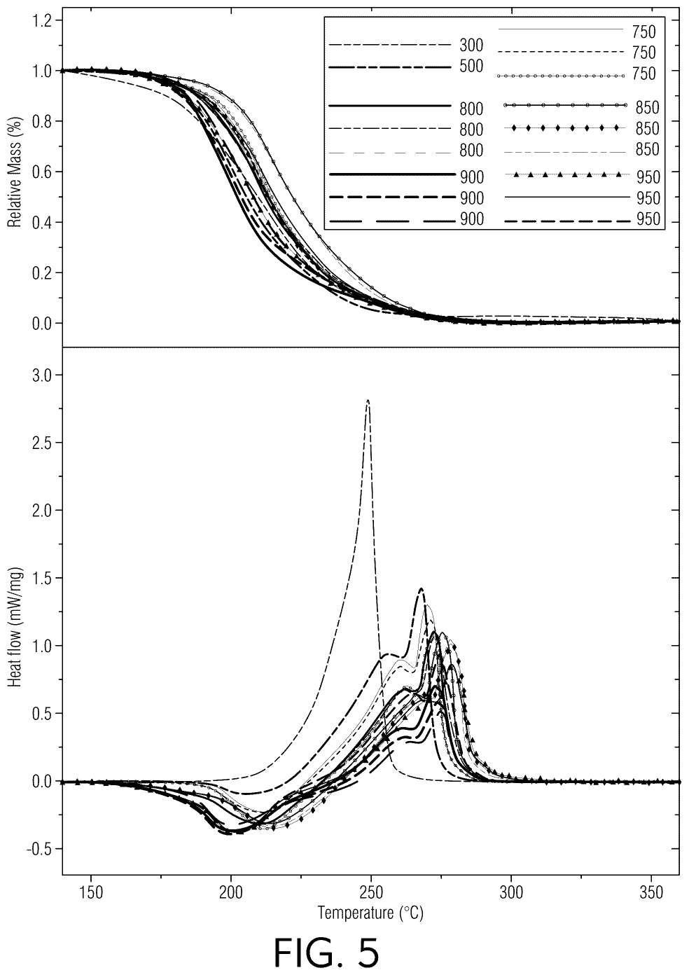

In FIG. 5, the thermogravimetric profile of Example Green Tapes T2 formed using Example Precursor Powder P2 heat treated at a furnace temperature from 300° C. to 950° C., fractional mass loss of 0.50 was observed at temperatures ranging from 202° C. to 223° C. Negligible sensitivity of the loss profiles to the precursor powder heat treatment temperature and furnace atmosphere was observed. The magnitude and temperature of peak heat flow was sensitive to the precursor powder heat treatment. With increasing precursor powder treatment temperature, the peak heat flow decreased from 2.80 mW/mg to a minimum value of 0.49 mW/mg. The corresponding peak temperatures exhibited a positive shift by about 30° C. An endothermic heat flow signature similar to Example Green Tapes T1 was observed for powders treated at temperatures greater than 300° C.

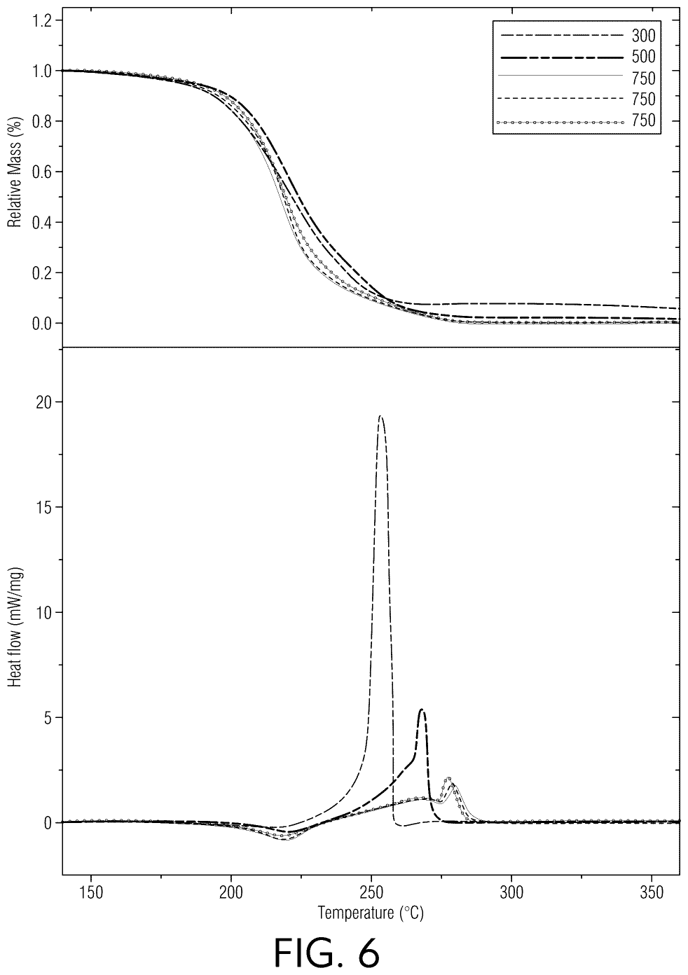

In FIG. 6, the thermogravimetric profile of Example Green Tables T3 formed using Example Precursor Powder P3 heat treated at a furnace temperature from 300° C. to 750° C., fractional mass loss of 0.5 was observed at temperatures ranging from 217° C. to 224° C. Two stages of mass loss were observed for powders treated at 300° C. With increasing treatment temperature, loss curves similar to Example Green Tapes T2 was observed. The peak heat flow was sensitive to the precursor powder heat treatment. With increasing precursor powder treatment temperature, the peak heat flow decreased from 19.20 mW/mg to a minimum value of 1.75 mW/mg. The corresponding peak temperatures exhibited a positive shift by about 26° C. An endothermic heat flow signature was observed for powders treated at temperature greater than 300° C.

Heat flow traces may also serve as a proxy as to the degradation of the binder. Polymer degradation mechanisms that underpin exothermic and endothermic heat signatures are chain scission and depolymerization, respectively. Endothermic degradation minimizes the heat release of the polymer. As shown in FIGS. 4-6, the lithium deficient surfaces enabled the endothermic degradation of the binder and increased separation of endothermic and exothermic events. After heat treating the powder, exothermic degradation occurred at a higher temperature, yielding more stable binder burnout. Particle size effects on heat release were also observed, with the magnitude of heat release suppression being more pronounced for Example Green Tapes T3 than Example Green Tapes T1 and T2.

As exemplified by FIGS. 4-6, heat treating precursor powders prior to tape casting removes lithium from the surfaces of the particles of the precursor powder, thereby stabilizing the sensitivity to binder pyrolysis and enabling relatively fast firing.

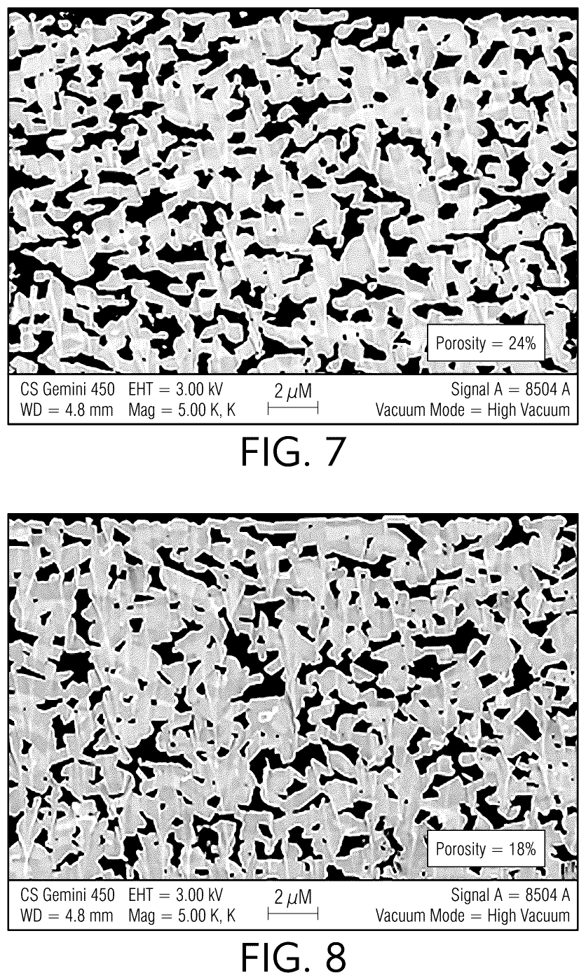

Example Ceramic Substrates S1 and S2 were formed from LCO precursor powders having a mean particles size of 0.6 μm. The precursor powders used to form Example Ceramic Substrate S1 were subjected to heat treatment at 150° C. for 2 hours under a humid atmosphere. The precursor powder used to form Example Ceramic Substrate S2 was subjected to heat treatment at 900° C. for 5 min under a humid atmosphere. The precursor powders were dispersed, tape cast, dried, debinded, and sintered to form the example ceramic substrates. Referring now to FIGS. 7 and 8, Example Ceramic Substrate S1 (FIG. 7) had a porosity of 24% and Example Ceramic Substrate S2 (FIG. 8) had a porosity of 18%. As exemplified by FIGS. 7 and 8, removing lithium from the surfaces of the particles of the precursor powder helps to promote improved sintering of the precursor powder, thereby decreasing the porosity of the ceramic substrate.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method of forming a ceramic substrate, the method comprising:
heating lithium cobaltite (LCO) precursor powder in a furnace at a furnace temperature greater than or equal to 300° C. and less than or equal to 950° C. to at least partially remove lithium from surfaces of particles of the LCO precursor powder;
dispersing the LCO precursor powder in a binder and solvent to form a slurry, the binder comprising poly(propylene carbonate), poly(propylene-co-cyclohexene carbonate), n-butyl methacrylate, polybutyl acrylate, poly(propylene), poly(isobutylene), poly(styrene-co-butadiene), poly(ethylene-co-vinyl acetate), poly(vinyl acetate), poly(vinyl alcohol), or combinations thereof;
tape casting the slurry to form a tape;
drying the tape to remove the solvent and form a green tape;
debinding the green tape to remove the binder and form a brown tape; and
sintering the brown tape to consolidate the LCO precursor powder and form a ceramic substrate.

2. The method of claim 1, wherein a debinding speed of the debinding is greater than 5 inches per minute.

3. The method of claim 1, wherein during the heating of the LCO precursor powder, the furnace comprises a humid atmosphere.

4. The method of claim 1, wherein during the heating of the LCO precursor powder, the furnace comprises a dry atmosphere.

5. The method of claim 1, wherein a mean particle size of the LCO precursor powder is greater than or equal to 0.1 μm and less than or equal to 1.5 μm.

6. The method of claim 1, wherein the heating the LCO precursor powder comprises heating the LCO precursor powder at the furnace temperature for greater than or equal to 0.1 hour and less than or equal to 10 hours.

7. The method of claim 1, wherein the solvent comprises dimethyl carbonate, methylethyl ketone, toluene, methoxypropyl acetate, ethanol, butanol, isopropanol, propylpropionate, dioxane, dioxolane, ethyl acetate, anisole, xylene, cyclopentane, cyclohexane, cyclohexanone, methyl isobutyl ketone, or combinations thereof.

8. The method of claim 1, wherein the slurry comprises:
greater than or equal to 20 wt % and less than or equal to 60 wt % of the LCO precursor powder;
greater than or equal to 5 wt % and less than or equal to 30 wt % of the binder; and
greater than or equal to 25 wt % and less than or equal to 60 wt % of the solvent.

9. The method of claim 1, wherein the slurry further comprises at least one of a plasticizer and a dispersant.

10. The method of claim 9, wherein the plasticizer comprises dibutyl phthalate, bis(2-ethylhexyl) phthalate, benzyl butyl phthalate, diisobutyl phthalate, diethyl phthalate, diisononyl phthalate, polyethylene glycol, propylene carbonate, or combinations thereof.

11. The method of claim 9, wherein the dispersant comprises oligomeric polyester, fatty acid, or combinations thereof.

12. The method of claim 1, wherein the dispersing of the LCO precursor powder comprises milling the LCO precursor powder in the binder and the solvent.

13. The method of claim 1, wherein the debinding comprises heating the green tape at a debinding temperature greater than or equal to 200° C. and less than or equal to 500° C.

14. The method of claim 1, wherein the debinding comprises heating the green tape for greater than or equal to 5 seconds and less than or equal to 120 seconds.

15. The method of claim 1, wherein the sintering comprises heating the brown tape at a sintering temperature greater than or equal to 1000° C. and less than or equal to 1200° C.

16. The method of claim 1, wherein the sintering comprises heating the brown tape for greater than or equal to 5 seconds and less than or equal to 600 seconds.

17. The method of claim 1, wherein the drying comprises heating the tape at a drying temperature greater than or equal to 100° C. and less than or equal to 300° C.

18. The method of claim 1, wherein the debinding the green tape and sintering the brown tape are a continuous process.

19. The method of claim 1, wherein a porosity of the ceramic substrate is less than or equal to 35%.

20. The method of claim 1, wherein a thickness of the ceramic substrate is greater than or equal to 5 μm and less than or equal to 125 μm.
